(19) United States
(12) Patent Application Publication
(10) Pub. No.: US 2022/0132899 A1
(43) Pub. Date: May 5, 2022

(54) SEASONING COMPOSITION FOR REDUCED-SODIUM COMESTIBLES

(71) Applicant: AJINOMOTO CO., INC., Tokyo (JP)

(72) Inventor: Tomohiro KODERA, Itasca, IL (US)

(73) Assignee: AJINOMOTO CO., INC., Tokyo (JP)

(21) Appl. No.: 17/498,072

(22) Filed: Oct. 11, 2021

Related U.S. Application Data
(60) Provisional application No. 63/107,125, filed on Oct. 29, 2020.

(51) Int. Cl. A23L 27/40; A23L 27/00; A23L 27/23; A23L 27/20

(52) U.S. Cl. CPC A23L 27/40; A23L 27/2028; A23L 27/23; A23L 27/88

(57) ABSTRACT

A seasoning composition, which includes (A) sodium chloride, (B) potassium chloride, (C) at least two nucleotides, and (D) glutamic acid or salt thereof. The seasoning composition is characterized as having a weight ratio of the at least two nucleotides to the glutamic acid or salt thereof, (C):(D), of from 1:1 to 5:1, and a weight ratio of potassium chloride to the glutamic acid or salt thereof, (B):(D), of from 10:1 to 250:1. Also disclosed are comestibles containing the seasoning composition, and methods of enhancing an initial salty taste of comestibles with the seasoning composition.

### BACKGROUND OF THE INVENTION

### Field of the Invention

The present invention relates to a seasoning composition, a comestible containing the seasoning composition, and a method of enhancing the salty taste of a comestible using the seasoning composition.

### Discussion of the Background

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Sodium chloride is a necessary nutritional component required in the amount of about 1,000 mg/day, and functions in foods as a taste enhancer, preservative (e.g., by suppressing microbial activity), texture modifier, and as a masking agent for off-notes. However, high sodium intake favors the body's retention of water, which can cause hypertension, a proven risk factor in the development of heart disease, heart failure, strokes, and kidney disease. In response, many national and international organizations such as U.S. Department of Health and Human Services and U.S. Department of Agriculture, UK Food Standards Agency, and the World Health Organization have published advisory guidelines for sodium intake, with key recommendations including consumption of less than about 2,300 mg sodium per day, less than 2,400 mg of sodium per day, and less than about 2,000 mg of sodium per day, respectively.

Yet, the average person is well above these recommendations. For example, the average American usually consumes 3,400 mg of sodium per day, while the European Food Safety Authority (EFSA) estimates that the average individual daily intake of sodium in Europe is 3,000 to 5,000 mg. There is thus a significant need to reduce dietary sodium intake, much of which (up to 75%) comes from processed foods manufactured by the food industry and the related food service sector.

The removal of sodium chloride from comestibles has thus far proven difficult because foods/drinks having a reduced amount of sodium chloride tend to taste plain and have a markedly reduced taste quality. Attempts to improve the taste of reduced-sodium comestibles often rely on the partial replacement of sodium chloride with potassium chloride, for example, through the use of sea salt. However, such foods/drinks still fall short of full sodium varieties with respect to the initial salty taste, and also in terms of aftertaste—as potassium chloride is known to impart undesirable taste characteristics, such as bitter, astringent, or metallic notes.

To reduce the undesirable aftertaste characteristics imparted by potassium chloride, savory taste modifiers (“umami” substances) can be added. For example, WO 2009/119892—incorporated herein by reference in its entirety uses a combination of monosodium glutamate (MSG) and inosine monophosphate (IMP). Even though umami substances have the ability to reduce or eliminate the objectionable aftertaste characteristics imparted by potassium chloride, they are not known for enhancing the salty taste itself, and in particular, are not known to improve the initial salty taste of the comestible.

The use of organic acid (food acid) has been reported to enhance the initial salty taste of reduced-sodium comestibles, but such organic acids impart a sourness that many consumers find unacceptable.

### SUMMARY OF THE INVENTION

In view of the forgoing, there is a need for seasoning compositions having a reduced-sodium content—through the partial replacement for sodium chloride with potassium chloride—which can be added to comestibles to provide reduced-sodium comestibles having an enhanced initial salty taste and overall salty taste profile similar to that of the full sodium version of the comestible, and doing so without imparting sourness.

Accordingly, it is one object of the present invention to provide novel seasoning compositions meeting the above criteria.

It is another object of the present disclosure to provide novel comestibles, which include the seasoning composition.

It is yet another object of the present invention to provide novel methods of enhancing an initial salty taste of a comestible, by incorporating the seasoning composition into the comestible.

These and other objects, which will become apparent during the following detailed description, have been achieved by the inventors' discovery that specific ratios of (A) sodium chloride, (B) potassium chloride, (C) at least two nucleotides, and (D) glutamic acid or salt thereof in a seasoning composition solves the aforementioned problems associated with reduced-sodium comestibles by enhancing the initial salty taste and the overall salty taste profile of the reduced-sodium comestible.

Thus, the present invention provides:

(1) A seasoning composition, comprising:

(A) sodium chloride;

(B) potassium chloride;

(C) at least two nucleotides; and

(D) glutamic acid or salt thereof;

wherein:

a weight ratio of the at least two nucleotides to the glutamic acid or salt thereof, (C):(D), is from 1:1 to 5:1, and

a weight ratio of potassium chloride to the glutamic acid or salt thereof, (B):(D), is from 10:1 to 250:1.

(2) The seasoning composition of (1), wherein a weight ratio of potassium chloride to sodium chloride, (B):(A), is less than 2:1.

(3) The seasoning composition of (1) or (2), wherein a weight ratio of potassium chloride to sodium chloride, (B):(A), is less than 1.5:1.

(4) The seasoning composition of any one of (1) to (3), wherein the at least two nucleotides are selected from the group consisting of, inosine monophosphate, guanosine monophosphate, and adenosine monophosphate.

(5) The seasoning composition of any one of (1) to (4), wherein the at least two nucleotides and the glutamic acid or salt thereof are provided in the form of a yeast extract.

(6) The seasoning composition of any one of (1) to (5), in which exactly two nucleotides are present.

(7) The seasoning composition of (6), wherein the two nucleotides are present in a weight ratio of 1:2 to 2:1.

(8) The seasoning composition of (6) or (7), wherein the two nucleotides are inosine monophosphate and guanosine monophosphate.

(9) The seasoning composition of any one of (1) to (8), wherein the glutamic acid or salt thereof is selected from the group consisting of glutamic acid, monosodium glutamate, monopotassium glutamate, calcium diglutamate, monoammonium glutamate, and magnesium diglutamate.

(10) The seasoning composition of any one of (1) to (9), wherein the weight ratio of the at least two nucleotides to the glutamic acid or salt thereof, (C):(D), is from 1.14:1 to 4.5:1.

(11) The seasoning composition of any one of (1) to (10), wherein the weight ratio of potassium chloride to the glutamic acid or salt thereof, (B):(D), is from 12:1 to 225:1.

(12) The seasoning composition of any one of (1) to (11), wherein a weight ratio of a combined weight of the at least two nucleotides and the glutamic acid or salt thereof to a combined weight of the sodium chloride and the potassium chloride, (C)+(D):(A)+(B), is less than 0.1:1.

(13) The seasoning composition of any one of (1) to (12), wherein a weight ratio of a combined weight of the at least two nucleotides and the glutamic acid or salt thereof to a combined weight of the sodium chloride and the potassium chloride, (C)+(D):(A)+(B), is from 0.005:1 to 0.085:1.

(14) The seasoning composition of any one of (1) to (13), wherein the glutamic acid or salt thereof is present in an amount of 0.1 to 10 wt %, based on a total weight of the seasoning composition on a dry basis.

(15) A comestible, comprising the seasoning composition of any one of (1) to (14).

(16) The comestible of (15), wherein:

a weight ratio of potassium chloride to sodium chloride, (B):(A), is less than 2:1, and

a weight ratio of a combined weight of the at least two nucleotides and the glutamic acid or salt thereof to a combined weight of the sodium chloride and the potassium chloride, (C)+(D):(A)+(B), is less than 0.1:1.

(17) The comestible of (15) or (16), which is a reduced-sodium comestible.

(18) A method of enhancing an initial salty taste of a comestible, comprising incorporating the seasoning composition of any one of (1) to (14) into the comestible.

(19) The method of (18), wherein:

a weight ratio of potassium chloride to sodium chloride, (B):(A), is less than 2:1, and

a weight ratio of a combined weight of the at least two nucleotides and the glutamic acid or salt thereof to a combined weight of the sodium chloride and the potassium chloride, (C)+(D):(A)+(B), is less than 0.1:1.

(20) The method of (18) or (19), wherein the comestible is a reduced-sodium comestible.

The foregoing paragraphs have been provided by way of general introduction, and are not intended to limit the scope of the following claims. The described embodiments, together with further advantages, will be best understood by reference to the following detailed description.

### DETAILED DESCRIPTION OF THE INVENTION

In the following description, it is understood that other embodiments may be utilized and structural and operational changes may be made without departure from the scope of the present embodiments disclosed herein.

### Definitions

As used herein, the phrase “substantially free”, unless otherwise specified, refers to a composition/material which contains less than 1 wt %, preferably less than 0._5 wt %, preferably less than 0.3 wt. %, preferably less than 0.2 wt. %, preferably less than 0.1 wt. %, preferably less than 0.05 wt. %, preferably less than 0.03 wt. %, preferably less than 0.02 wt. %, preferably less than 0.01 wt. %, preferably less than 0.001 wt. %, preferably less than 0.0001 wt. %, preferably 0 wt. % of a particular component, relative to a total weight of the composition/material.

As used herein, the terms “optional” or “optionally” means that the subsequently described event(s) can or cannot occur or the subsequently described component(s) may or may not be present (e.g., 0 wt. %).

When referencing weight percentages, the phrase “dry basis” denotes that the weight percentage does not include the weight of water, if/when water is present. For example, an aqueous sea salt solution containing 1 wt. % of sodium chloride and 1 wt. % potassium chloride, would provide 50 wt. % of sodium chloride, based on a total weight of the aqueous sea salt solution on a dry basis.

As used herein, the phrase “reduced-sodium”, unless otherwise specified, refers to comestibles which have a sodium content that is reduced by at least 25 wt. %, compared to the regular (full sodium) version. As used throughout the specification, this phrase thus encompasses light in sodium comestibles, which have a sodium content that is reduced by at least 50 wt % compared to the regular (full sodium) version); low sodium comestibles, which contain 140 mg Na or less per 100 g of the comestible; as well as very low sodium comestibles, which contain 35 mg Na or less per 100 g of the comestible. The phrase “sodium-free” as used herein refers to comestibles which contain less than 5 mg Na or less per 100 g of the comestible.

As used herein, the phrase “overall salty taste” and the like, refers to the complete perception of saltiness (salt intensity and associated taste characteristics) one experiences upon consuming a comestible. The “overall salty taste” is composed of three parts: “initial salty taste”, “middle salty taste”, and “aftertaste”. The “initial salty taste” is defined herein as the perception of saltiness (salt intensity and associated taste characteristics) one experiences within the first two seconds upon placing a comestible into the oral cavity—the initial salty taste may thus be thought of as the first impression of saltiness one perceives; the “aftertaste” is defined herein as the perception of saltiness (salt intensity and associated taste characteristics) remaining or lingering in the mouth after the comestible has been consumed/ingested; while the “middle salty taste” is defined as the perception of saltiness (salt intensity and associated taste characteristics) one experiences after the initial salty taste, i.e., after two seconds, but before the comestible is consumed/ingested.

### Seasoning Composition

The present disclosure is directed to seasoning compositions having a reduced-sodium content, which can be added to a comestible to provide a reduced-sodium comestible with an excellent initial salty taste and overall salty taste profile similar to the full sodium variety of the comestible that consumers find enjoyable. Depending on the comestible, the seasoning composition may be in the form of a dry blend that is substantially free of water or a wet blend, e.g., as an aqueous solution.

Such seasoning compositions generally include: a salt mixture of (A) sodium chloride and (B) potassium chloride; as well as (C) at least two nucleotides and (D) glutamic acid or salt thereof as umami substances; and optionally an amino acid or salt thereof (other than glutamic acid) and a food acid.

### <Salt Mixture>

### (A) Sodium Chloride

The seasoning composition of the present disclosure is formulated with sodium chloride, including any hydrates thereof, which is primarily responsible for salt taste enhancement when the seasoning composition is added to a comestible. The seasoning composition may be formulated with wide ranging amounts of sodium chloride to achieve desirable taste enhancement. However, with the objective of minimizing sodium intake as much as possible, preferred seasoning compositions are those which have as little sodium chloride as needed for delivering satisfactory saltiness profiles to comestibles. In this regard, the seasoning compositions preferably include at least 25 wt. %, preferably at least 30 wt. %, preferably at least 35 wt. %, preferably at least 40 wt. %, preferably at least 42 wt. %, preferably at least 44 wt. %, and up to 75 wt. %, preferably up to 70 wt. %, preferably up to 65 wt. %, preferably up to 62 wt. %, preferably up to 60 wt. %, preferably up to 58 wt. %, preferably up to 56 wt. %, preferably up to 54 wt. %, preferably up to 52 wt. %, preferably up to 50 wt. %, preferably up to 48 wt. %, preferably up to 47 wt. % of sodium chloride, based on a total weight of the seasoning composition (dry basis).

### (B) Potassium Chloride

Potassium chloride is used herein as a partial replacement for sodium chloride. A desirable overall salty taste profile may be afforded by the seasoning composition when the weight ratio of potassium chloride to sodium chloride, (B):(A), is less than 2:1, preferably less than 1.9:1, preferably less than 1.8:1, preferably less than 1.7:1, preferably less than 1.6:1, preferably less than 1.5:1, preferably less than 1.4:1, preferably less than 1.3:1.

For example, it is preferred that the weight ratio of potassium chloride to sodium chloride, (B):(A), be at least 0.33:1, preferably at least 0.4:1, preferably at least 0.45:1, preferably at least 0.5:1, preferably at least 0.55:1, preferably at least 0.6:1, preferably at least 0.65:1, preferably at least 0.7:1, preferably at least 0.75:1, preferably at least 0.8:1, preferably at least 0.85:1, preferably at least 0.9:1, preferably at least 0.95:1, preferably at least 1:1, and up to 1.9:1, preferably up to 1.8:1, preferably up to 1.7:1, preferably up to 1.6:1, preferably up to 1.5:1, preferably up to 1.4:1, preferably up to 1.3:1, preferably up to 1.2:1, preferably up to 1.1:1.

When the ratio of potassium chloride to sodium chloride, (B):(A), is above the aforementioned upper limit value, there is not enough sodium chloride present, and too much potassium chloride, and the undesirable aftertaste characteristics (e.g., astringency, metallic flavors, etc.) imparted by potassium chloride are too strong for the umami substances to compensate.

When the ratio of potassium chloride to sodium chloride, (B):(A), is below the lower limit above, the salty taste profile is generally very good, however the benefits of the present disclosure are diminished in terms of lowering the sodium chloride content and providing a reduced-sodium alternative to full sodium comestibles.

The sodium chloride and the potassium chloride may be added separately or may be pre-mixed in a particular ratio, for example in the case of using a sea salt as the salt mixture. Exemplary sea salts include, but are not limited to, TWO SEAS LOW SODIUM SEA SALT SS50 NF (KCl/NaCl=50/50 by weight), available from A & B Ingredients, Inc., and SALTWELL DRY ANTICAKE RICE HULL CONCENTRATE 275801 (KCl/NaCl=30/70 by weight), available from Hanson & Mohring.

In some embodiments, the salt mixture component of the seasoning composition is formulated in dry form, that is, sodium chloride and potassium chloride are added as a dry blend which is substantially free of water. In some embodiments, the salt mixture component of the seasoning composition is added as an aqueous salt solution, as may be desirable for use in liquid comestibles (e.g., sauces, drinks, soups, etc.).

Besides potassium chloride, other salts which are contemplated herein as a partial replacement for sodium chloride include, but are not limited to, ammonium chloride, potassium magnesium chloride (carnallite), potassium-magnesium sulfate-chloride (kainite), potassium magnesium sulfate (langbeinite), sulfates of potassium, calcium and magnesium (polyhalite), magnesium sulfate (kieserite), and the like, as well as any hydrates thereof

### <Umami Substances>

The umami portion of the seasoning composition of the present disclosure includes at least two nucleotides and glutamic acid or salt thereof. These umami substances may be added as separate components, or may be added together, for example, the umami substances may be provided in the form of a yeast extract.

### (C) At Least Two Nucleotides

Nucleotides are composed of thee subunit molecules: a nitrogenous base (also known as nucleobase), a five-carbon sugar (ribose or deoxyribose), and a phosphate group (one to three phosphates). The seasoning composition of the present disclosure may be formulated with any two or more such nucleotides, or three or more such nucleotides, or four or more such nucleotides, inclusive of any salts thereof, in any ratio which provides or potentiates an umami (savoriness) effect. While pyrimidine-based nucleotides are contemplated, preferred nucleotides to be used herein are those formed from a purine nucleobase (e.g., adenine, guanine) or a nucleobase of a purine derivative (e.g., hypoxanthine, xanthine, etc.). In preferred embodiments, the nucleotides are 5′-ribonucleotides. Also preferred are those nucleotides composed of one phosphate (monophosphates).

Examples of nucleotides which can be used in combination of any two or more in the disclosed seasoning composition, include, but are not limited to, inosine monophosphate (IMP), guanosine monophosphate (GMP), adenosine monophosphate (AMP), mono- or disodium inosinate, mono- or dipotassium inosinate, calcium inosinate, mono- or disodium guanylate, mono- or dipotassium guanylate, calcium guanylate, mono- or di sodium adenylate, mono- or dipotassium adenylate, and calcium adenylate.

The seasoning composition may contain two (2) nucleotides. In such cases, the two nucleotides may be present in a weight ratio (first nucleotide to second nucleotide) of at least 1:2, preferably at least 1:1.8, preferably at least 1:1.6, preferably at least 1:1.4, preferably at least 1:1.2, preferably at least 1:1, and up to 2:1, preferably up to 1.8:1, preferably up to 1.6:1, preferably up to 1.4:1, preferably up to 1.2:1. In preferred embodiments, the two nucleotides are inosine monophosphate (first nucleotide) and guanosine monophosphate (second nucleotide).

It has been found that a desirable overall salty taste profile, and in particular an enhanced initial salty taste, may only be provided when the seasoning composition is formulated with at least two nucleotides. On the other hand, it has been found that seasoning compositions which include only one nucleotide, or where the at least two nucleotides are replaced with a food acid (e.g., disodium succinate), lack an acceptable initial salty taste.

### (D) Glutamic Acid or Salt Thereof

The seasoning composition is also to be formulated with glutamic acid or salt thereof as an umami substance. Suitable examples of the glutamic acid or salt thereof include, but are not limited to, glutamic acid (L-glutamic acid), monosodium glutamate (MSG), monopotassium glutamate (MPG), calcium diglutamate, monoammonium glutamate, and magnesium diglutamate, as well as mixtures thereof. In terms of enhancing the initial salty taste and overall salty taste profile of comestibles, any of the above listed glutamic acids or salts thereof may be used in combination with sodium chloride, potassium chloride, and the at least two nucleotides as discussed above. However, in terms of limiting sodium intake, preferred seasoning compositions are those which utilize a non-sodium cation variety of glutamate, that is, glutamic acid or a glutamate other than MSG. In this regard, particular preference is given to seasoning compositions which include glutamic acid.

Amounts of glutamic acid or salt thereof employed in the seasoning composition typically range from at least 0.1 wt. %, preferably at least 0.2 wt. %, preferably at least 0.3 wt. %, preferably at least 0.4 wt. %, preferably at least 0.5 wt. %, preferably at least 0.6 wt. %, preferably at least 0.7 wt. %, preferably at least 0.8 wt. %, preferably at least 0.9 wt. %, preferably at least 1 wt. %, preferably at least 1.2 wt. %, preferably at least 1.4 wt. %, preferably at least 1.5 wt. %, and up to 10 wt. %, preferably up to 9.5 wt. %, preferably up to 9 wt. %, preferably up to 8.5 wt. %, preferably up to 8 wt. %, preferably up to 7.5 wt. %, preferably up to 7 wt. %, preferably up to 6.5 wt. %, preferably up to 6 wt. %, preferably up to 5.5 wt. %, preferably up to 5 wt. %, preferably up to 4.5 wt %, preferably up to 4 wt. %, preferably up to 3.5 wt. %, preferably up to 3 wt. %, preferably up to 2.5 wt. %, preferably up to 2 wt. %, based on a total weight of the seasoning composition on a dry basis.

An acceptable overall salty taste profile may be afforded by the seasoning composition when the weight ratio of the at least two nucleotides to the glutamic acid or salt thereof, (C):(D), is from at least 1:1, preferably at least 1.1:1, preferably at least 1.14:1, preferably at least 1.2:1, preferably at least 1.25:1, preferably at least 1.3:1, preferably at least 1.35:1, preferably at least 1.4:1, preferably at least 1.45:1, preferably at least 1.5:1, and up to 5:1, preferably up to 4.5:1, preferably up to 4:1, preferably up to 3.5:1, preferably up to 3:1, preferably up to 2.5:1, preferably up to 2:1. Particularly preferred weight ratios of the at least two nucleotides to the glutamic acid or salt thereof, (C):(D), in terms of providing a strong overall salt enhancement are those of from at least 1.14:1, preferably at least 1.2:1, preferably at least 1.25:1, preferably at least 1.3:1, preferably at least 1.35:1, preferably at least 1.4:1, preferably at least 1.45:1, preferably at least 1.5:1, and up to 4:1, preferably up to 3.5:1, preferably up to 3:1, preferably up to 2.5:1, preferably up to 2:1.

When the weight ratio of the at least two nucleotides to the glutamic acid or salt thereof, (C):(D), falls outside of the aforementioned range, the seasoning composition fails to provide an overall salt enhancement to reduced-sodium comestibles.

In terms of delivering an overall salty taste enhancement, while also providing an adequate reduction of sodium chloride content, preferred seasoning compositions are those having a weight ratio of potassium chloride to the glutamic acid or salt thereof, (B):(D), of at least 10:1, preferably at least 12:1, preferably at least 14:1, preferably at least 16:1, preferably at least 18:1, and up to 250:1, preferably up to 225:1, preferably up to 200:1, preferably up to 175:1, preferably up to 150:1, preferably up to 125:1, preferably up to 100:1, preferably up to 75:1, preferably up to 50:1, preferably up to 45:1, preferably up to 40:1, preferably up to 35:1, preferably up to 30:1, preferably up to 25:1, preferably up to 24:1, preferably up to 22:1, preferably up to 20:1.

Additionally, to provide an overall salty taste profile similar to that of the full sodium version of the comestible, the seasoning compositions should also strike a balance between the savory and salty taste. It has been found that an acceptable balance can be achieved when the weight ratio of the total amount of umami substances to the total amount of the salt mixture is less than 0.1:1. Thus, in some embodiments, a weight ratio of a combined weight of the at least two nucleotides and the glutamic acid or salt thereof to a combined weight of the sodium chloride and the potassium chloride, (C)+(D):(A)+(B), is less than 0.1:1, for example at least 0.005:1, preferably at least 0.006:1, preferably at least 0.007:1, preferably at least 0.008:1, preferably at least 0.009:1, preferably at least 0.01:1, preferably at least 0.015:1, preferably at least 0.020:1, preferably at least 0.025:1, preferably at least 0.030:1, and up to 0.095:1, preferably up to 0.092:1, preferably up to 0.090:1, preferably up to 0.088:1, preferably up to 0.086:1, preferably up to 0.085:1, preferably up to 0.084:1, preferably up to 0.082:1, preferably up to 0.080:1, preferably up to 0.078:1, preferably up to 0.076:1.

In some embodiments, the umami substances (e.g., the at least two nucleotides and the glutamic acid or salt thereof) are provided in the form of a yeast extract. Thus, the seasoning composition may be incorporated into a comestible by adding the salt mixture of sodium chloride and potassium chloride, together or separately, and a yeast extract comprising the umami substances, namely the at least two nucleotides and the glutamic acid or salt thereof.

The yeast used to form the yeast extract is not particularly limited, so long as it can be applied in the field of food manufacturing. Yeasts may belong to a genus such as Saccharomyces, Schizosaccharomyces, Pichia, Candida, Kluyveromyces, Williopsis, Debaryomyces, Galactomyces, Torulasupora, Rhodotorula, Yarrowia, and Zygosaccharomyces. The yeast is preferably a high proliferating yeast such as a baker's yeast used for bread manufacturing, torula yeast used for manufacturing foods, feeds, and so forth, or brewer's yeast used for beer manufacturing, with particularly preferred yeasts belonging to the genus Saccharomyces or Candida. Examples of yeast belonging to the genus Saccharomyces include, but are not limited to, Saccharomyces cerevisiae. Examples of the yeast belonging to the genus Candida include, but are not limited to, Candida tropicalis, Candida lipolytica, Candida utilis, and Candida sake. Preferred examples are yeast strains of Saccharomyces cerevisiae or Candida utilis.

The yeast extract may be prepared using methods known by those of ordinary skill in the art, for example using autolysis methods, enzyme decomposition methods, methods of chemical decomposition by acid or alkali, hot water extraction methods, and the like, such as those described in U.S. Pat. No. 4,303,680, US20190045820A1, US20110223287A, US2018070623A1, JP2833037B2, JPH01281057A—each incorporated herein by reference in its entirety.

The form of the yeast extract is not particularly limited, and may be used in the form of a concentrate, a partially purified crude product, a liquid, a paste, a dry substance, a powder, a granule, and the like, depending on the particular application. For example, when the seasoning composition is to be applied as a dry blend, preferred yeast extracts are those in a powder form. For applications in sauces, broths, or other liquid comestibles, it may be appropriate to use a paste-type yeast extract.

The content of glutamic acid or salt thereof and the content of nucleotides contained in the yeast extract may vary so long as the yeast extract includes an amount of glutamic acid or salt thereof and at least two nucleotides suitable to provide the desired taste enhancement. Preferred yeast extracts are those which are glutamic acid/glutamate-rich yeast extracts, and even more preferred are those which are glutamic acid/glutamate-rich and nucleotide-rich yeast extracts. In some embodiments, the yeast extract has a content of glutamic acid or salt thereof of at least 1 wt. %, preferably at least 2 wt. %, preferably at least 3 wt. %, preferably at least 4 wt %, preferably at least 5 wt. %, preferably at least 6 wt. %, preferably at least 7 wt. %, preferably at least 8 wt. %, and up to 20 wt. %, preferably up to 18 wt. %, preferably up to 16 wt. %, preferably up to 14 wt. %, preferably up to 12 wt. %, preferably up to 10 wt. %, preferably up to 9 wt. %, based on a total weight of the yeast extract. In some embodiments, the yeast extract has a content of at least two nucleotides (e.g., IMP and GMP) of at least 2 wt. %, preferably at least 4 wt. %, preferably at least 6 wt. %, preferably at least 8 wt. %, preferably at least 10 wt. %, preferably at least 12 wt. %, preferably at least 14 wt. %, preferably at least 16 wt. %, preferably at least 18 wt. %, preferably at least 20 wt. %, and up to 50 wt. %, preferably up to 45 wt. %, preferably up to 40 wt. %, preferably up to 35 wt. %, preferably up to 30 wt. %, preferably up to 25 wt. %, preferably up to 22 wt. %, based on a total weight of the yeast extract.

The amount of yeast extract incorporated into the seasoning composition may be adjusted depending upon the content of the umami substances contained therein. Suitable amounts of yeast extract are those which provide the amounts of the at least two nucleotides and the glutamic acid or salt thereof, within the defined ratios, as described heretofore.

Specific examples of yeast extracts that can be used herein include, but are not limited to, YEASTOCK HG-PdD20, YEASTOCK HG-Ps, and YEASTOCK HR-Pd, each available from Asahi Group Foods, Ltd., and SUPER YE, available from Ajinomoto Co., Inc.

In addition to glutamic acid or a salt thereof, the seasoning composition herein may optionally be formulated with one or more other free amino acids or their salts. This may be the case particularly when the umami substances are provided in the form of a yeast extract, as the yeast extract will typically also contain other free amino acids and their salts, in addition to glutamic acid or a salt thereof. Examples of other amino acids (i.e., other than glutamic acid) may include, but are not limited to, aspartic acid, asparagine, threonine, serine, glutamine, glycine, alanine, cysteine, valine, methionine, isoleucine, leucine, tyrosine, phenylalanine, lysine, arginine, histidine, proline, etc.), as well as any salts thereof. When one or more other amino acids are present in the seasoning composition, it is preferred that glutamic acid or a salt thereof is present in a higher quantity than any other single amino acid. For example, a weight ratio of glutamic acid or a salt thereof to any other single amino acid (e.g., glutamic acid to alanine) present in the seasoning composition may range from greater than 1:1, preferably at least 1.2:1, preferably at least 1.4:1, preferably at least 1.6:1, preferably at least 1.8:1, preferably at least 2:1, preferably at least 2.5:1, preferably at least 3:1, preferably at least 4:1, preferably at least 5:1, preferably at least 6:1, preferably at least 7:1, preferably at least 8:1, preferably at least 9:1, preferably at least 10:1, and for example up to 500:1, preferably up to 400:1, preferably up to 300:1, preferably up to 200:1, preferably up to 100:1, preferably up to 75:1, preferably up to 50:1, preferably up to 40:1, preferably up to 30:1, preferably up to 20:1. In some embodiments, glutamic acid or a salt thereof is the only free amino acid present in the seasoning composition.

The seasoning composition may also optionally be formulated with other umami substances (savory taste modifying substances) known to those of ordinary skill in the art, in art appropriate levels, including, but not limited to, peptides, peptide fragments, protein hydrolysates (e.g., vegetable peptide hydrolysate or hydrolyzed vegetable proteins (HVP), as well as animal hydrolysates such as chicken hydrolysates), and small molecule savory flavor modulating agents such as those disclosed in US20060257543 and US20130196050—each incorporated herein by reference in its entirety. In some embodiments, the at least two nucleotides and glutamic acid or salt thereof are the only umami substances present in the seasoning composition.

The seasoning composition may also optionally be formulated with one or more food acids. The amount of food acid employed in the disclosed seasoning composition may vary, but typically ranges from at least 0.1 wt. %, preferably at least 0.2 wt. %, preferably at least 0.3 wt. %, preferably at least 0.4 wt. %, preferably at least 0.5 wt. %, preferably at least 0.6 wt. %, preferably at least 0.7 wt. %, preferably at least 0.8 wt. %, preferably at least 0.9 wt. %, preferably at least 1 wt. %, preferably at least 1.2 wt. %, preferably at least 1.4 wt. %, preferably at least 1.5 wt. %, and up to 10 wt. %, preferably up to 9.5 wt. %, preferably up to 9 wt. %, preferably up to 8.5 wt. %, preferably up to 8 wt. %, preferably up to 7.5 wt. %, preferably up to 7 wt. %, preferably up to 6.5 wt. %, preferably up to 6 wt. %, preferably up to 5.5 wt. %, preferably up to 5 wt. %, preferably up to 4.5 wt. %, preferably up to 4 wt. %, preferably up to 3.5 wt. %, preferably up to 3 wt. %, preferably up to 2.5 wt. %, preferably up to 2 wt. %, based on a total weight of the seasoning composition on a dry basis. Examples of food acids include, but are not limited to, carboxylic acids such as acetic acid (vinegar), ascorbic acid, fumaric acid, malic acid, tartaric acid, citric acid, lactic acid, folic acid, and succinic acid, including any salts thereof (e.g., disodium succinate). In preferred embodiments, the seasoning composition herein is substantially free of food acids, so as to not introduce sour taste notes to the comestibles, for example.

The seasoning composition may also optionally be formulated with one or more additives to prevent the composition from segregation, agglomeration and solidification. Examples of additives include, but are not limited to, oil and silicon dioxide.

### Comestible

The present disclosure also provides a comestible which includes the seasoning composition, in one or more of its embodiments. While in principle the seasoning composition may be used to make comestibles which do not have a reduced-sodium content, preferred comestibles of the present disclosure are reduced-sodium comestibles containing the seasoning composition. For example, preferred comestibles are those in which the full sodium chloride content associated with the full sodium version of the comestible is at least partially or completely replaced with the seasoning composition. Thus, in preferred embodiments, the comestible containing the seasoning composition is a reduced-sodium comestible with a sodium content that is reduced by at least 25 wt. %, preferably at least 30 wt. %, preferably at least 35 wt. %, preferably at least 40 wt. %, preferably at least 45 wt. %, preferably at least 50 wt. %, preferably at least 55 wt. %, preferably at least 60 wt. %, preferably at least 65 wt. %, preferably at least 70 wt. %, preferably at least 75 wt. %, preferably at least 80 wt. %, preferably at least 85 wt. %, preferably at least 90 wt. %, compared to the regular (full sodium) version of the comestible. The comestible formulated with the seasoning composition may thus be a reduced-sodium comestible, a light in sodium comestible, a low sodium comestibles, or a very low sodium comestible.

As comestibles vary widely in terms of their salt content or saltiness, the amount of the seasoning composition to be included in the comestible may also vary widely. For example, comestibles traditionally having a less salty taste may include only low quantities of the seasoning composition, whereas comestibles which are traditionally very salty may contain the seasoning composition in high quantities. A person of ordinary skill in the art will be able to determine the appropriate amount of the seasoning composition to add for acceptable taste and also for adequate sodium level reduction. A typical amount of seasoning composition (dry basis) to be employed is from of at least 0.01 wt. %, preferably at least 0.05 wt. %, preferably at least 0.1 wt. %, preferably at least 0.15 wt. %, preferably at least 0.2 wt. %, preferably at least 0.25 wt. %, preferably at least 0.3 wt. %, preferably at least 0.35 wt. %, preferably at least 0.4 wt. %, preferably at least 0.45 wt. %, preferably at least 0.5 wt. %, and up to 5 wt. %, preferably up to 4 wt. %, preferably up to 3 wt. %, preferably up to 2.8 wt. %, preferably up to 2.6 wt. %, preferably up to 2.4 wt. %, preferably up to 2.2 wt. %, preferably up to 2 wt. %, preferably up to 1.8 wt. %, preferably up to 1.6 wt. %, preferably up to 1.4 wt. %, preferably up to 1.2 wt. %, preferably up to 1 wt. %, preferably up to 0.8 wt. %, preferably up to 0.6 wt. %, based on a total weight of the comestible, although lower or higher loadings of the seasoning composition are also contemplated.

Any type of comestible in which a salty taste is desired can be prepared using the seasoning composition of the present disclosure. Exemplary comestibles include, but are not limited to,
seasonings such as miso, soy sauce, dashi, and barbecue rubs;
dressings, condiments, and marinades, such as mayonnaise, tomato ketchup, mustard, salad dressings (regular or low fat), vinaigrettes, dips, barbecue sauces, ranch dressing, thousand island dressing, creamy Italian dressing, tartar sauce, aioli, fry sauce, Marie Rose sauce, rouille sauce, salsa golf sauce, and remoulade;
soups and soup bases, including wet soups, clear soups, chowders, stews, stocks, semi-condensed soups, and condensed soups, such as miso soup, Japanese-style soup (osuimono), consommé soup (e.g., chicken consommé, beef consommé), egg soup, seaweed soup, potage, canned soup, dehydrated soup, instant soup, chilled soup, frozen soup, bouillon cubes, stock cubes, gravy granules, liquid stocks, fish stock, bouillabaisse, chicken soup, corn soup, onion soup, tomato soup, celery soup, onion soup, carrot soup, potato soup, mushroom soup, leek soup, miso soup, Japanese clear soup, ramen noodle soup, Japanese noodle soup, and cream or cheese-based soups;
sauces such as pasta sauces, tomato sauce, tomato pastes and purees, fermented sauces, soy based sauces, wet sauces, dry sauces/powder mixes, Worcestershire sauce, sauce for pork cutlets, soy sauce, teriyaki sauce, noodle dipping sauce, béchamel or white sauce, demiglace sauce, meat sauce, curry roux, carbonara, and bolognese;
meat products including livestock processed meats, such as chicken, ham (e.g., boneless ham, pork loin ham, raw ham, bone-in ham, and pressed ham), sausage (e.g., Vienna sausage, dry sausage, Frankfurt sausage, Boronia sausage, and Lyonnaise sausage), bacon, corned beef, roast pork, fish/seafood, canned meat, canned fish/seafood, frozen processed red meat, frozen processed poultry, frozen processed fish/seafood, ground fish meat products, surimi, chikuwa (fishcake tube), sasa-kamaboko (bamboo grass leaf-shaped steamed fish paste), datemaki (tightly rolled sweet fish omelette), kamaboko (steamed fish paste), fish sausage, hanpen (puffy cake of steamed ground fish combined with starch), tsumire (dumpling made of ground fish), narutomaki (fish paste loaf), Satsuma-age (deep-fried ground fish paste), ebiten (deep-fried ground fish and prawn), and jakoten (deep-fried ground small fish);
vegetables and fruits including canned varieties, such as canned tomatoes, canned beans, canned fruit, frozen processed vegetables, frozen potatoes, oven baked vegetable products such as oven baked potato products, non-oven frozen potatoes, pickled products (e.g., pickles in vinegar, pickles in salt) or other preservable foods, and vegetable proteins such as structured soy protein;
milk products such as cheese, processed cheese, spreadable and nonspreadable cheese, and yogurts;
confectionery and snack foods such as potato chips, oven baked potato chips, popcorn, crackers, biscuits, pretzels, cookies, pudding, frozen desserts, and dessert mixes;
cooked foods or ready-made dishes such as boiled food, fried food, roasted food, curry, pizza, fried potato, fried chicken, fried fish, ready meals, canned ready meals, frozen ready meals, dried ready meals, dinner mixes, frozen pizza, lunch kits, pasta, potato and rice dishes, rice gruel, rice soup, and ochazuke;
drinks such as tomato juice;
breads such as nan, edible wrapping sheet (e.g., pizza crust, pie crust, wrapping sheet for gyoza, wrapping sheet for shumai), tortilla, taco shell, cornflakes, pastas and noodles, wheat noodles (udon), Japanese noodles, ramen, canned pasta, dried pasta, chilled/fresh pasta, instant noodles, cups/bowl instant noodles, pouch instant noodles, and snack noodles.

The comestibles may be manufactured using the seasoning composition of the present disclosure, and any other raw or base ingredient(s) traditionally used to prepare the comestible. Examples of raw or base ingredients that may be used to prepare the comestible include, but are not limited to,
egg products such as egg yolks, egg whites, enzyme modified egg yolks, lyophilized (powdered) egg yolks, or emulsifier-fortified egg yolks;
oils and fats, such as vegetable and seed oils, cooking fats, butter, margarine, spreadable oils and fats, functional spreadable oils and fats, chicken fat, triglycerides, diglycerides, monoglycerides, olive oil, vegetable oil, canola oil, soybean oil, corn oil, jojoba oil, coconut oil, peanut oil, sunflower oil, sesame oil, palm oil, rice germ oil (rice bran oil), safflower oil, cottonseed oil, lard oil, fish oil, and castor oil;
grains and legumes such as corn, millet, sorghum, barley, oats, rice, rye, teff, wheat, wild rice, beans, peanuts, mustard seeds, and flax;
flavorants, herbs, and spices, such as oregano, basil, parsley, chives, pepper (e.g., black pepper, white pepper), mustard, coriander, curry, chili powder, chili sauce, lavender, rosemary, chervil, anise seed, garlic, onion, cilantro, horseradish, fennel seed, bay leaves, caraway seeds, celery seed, allspice, nutmeg, paprika, thyme, tarragon, turmeric, dill, sage, saffron, poppy seed, sesame seed, marjoram, mint, cayenne pepper, red/green pepper, mace, chipotle, cinnamon, fenugreek, ginger, wasabi, sugars (e.g., monosaccharides such as one or more of fructose and glucose, disaccharides such as sucrose) or other sweeteners (e.g., brown sugar, molasses, corn syrup, high fructose corn syrup, light corn syrup, dark corn syrup, maltodextrin, corn sweetener, artificial sweeteners), peppers, soy sauce/soy sauce base (e.g., pasteurized moromi, soy sauce concentrate, hydrolyzed vegetable protein, high-salt liquid-state fermented soy sauce, low-salt solid-state fermented soy sauce), brandy, dairy flavors, chicken flavors, beef flavors, or any other spice flavors;
vegetables, including dried vegetables, pickled vegetables, fresh vegetables, cooked (e.g., baked) vegetables, and juice obtained from such vegetables, such as relish, tomato, potato, carrot, turnip, spinach, lettuce, onion, pepper, celery, parsnip, asparagus, eggplant, bok Choy, brussel sprouts, cabbage, corn, pumpkin, cucumber, squash, peas, beets, broccoli, gherkins/pickles, and capers;
proteins, including animal proteins and vegetable proteins, such as poultry, fish (e.g., anchovy), shellfish, beef, turkey, chicken, pork (e.g., bacon), lamb, dairy, whey, egg, structured soy protein, and legume proteins;
stocks and stock powders such as chicken stock powder, onion powder, vegetable powder;
emulsifiers such as polysorbates (e.g., polyoxyethylene sorbitan monolaurate, polyoxyethylene sorbitan monopalmitate, polyoxyethylene sorbitan monostearate, polyoxyethylene sorbitan monooleate, and sorbitan tri stearate), phospholipids (e.g., phosphatidic acid, phosphatidylethanolamine, phosphatidylcholine, phosphatidylserine, phosphatidylinositol, phosphatidylinositol phosphate, phosphatidylinositol bisphosphate, phosphatidylinositol triphosphate, ceramide phosphoryl choline, ceramide phosphorylethanolamine and ceramide phosphoryl glycerol), casein, albumin, and glycerol monostearate;
acidulants such as vinegar, a citrus juice (e.g., a juice from lemons, oranges, grapefruits, limes, and/or tangerines), a phosphoric acid, a bisulfate (e.g., sodium bisulfate), and lactic acid;
dairy products, including fresh and dehydrated forms, such as whole buttermilk, skim buttermilk, whole milk, 2% milk, 1% milk, skim milk, sour cream, and yogurt;
preservatives such as benzoates (e.g., sodium benzoate, benzoic acid), sorbates (e.g., sorbic acid, sodium sorbate, potassium sorbate, calcium sorbate), propionates (e.g., propionic acid), ascorbates and stereoisomers (e.g., ascorbic acid, sodium ascorbate, erythorbic acid, sodium erythorbate), rosemary extract, alpha-tocopherol (vitamin E), kojic acid, tannins, flavonoids, phenolic acids, aminopolycarboxylic acids, and organic hydroxy acids;
thickening agents, including starch, modified starch, and gums, such as maltodextrin, xanthan gum, guar gum, carrageenan, salts of alginic acid (e.g., sodium alginate, potassium alginate, ammonium alginate, and/or calcium alginate), locust bean gum, agar, tapioca, gelatin, pectin, gum arabic (acacia), inulin, propylene glycol alginates, blends of gums (e.g., CARAGUM available from TIC gums), cold-water swellable and cold water soluble starches derived from waxy maize or tapioca (e.g., ULTRASPERSE M, ULTRASPERSE SR, and INSTANT TEXTRA, each available from Ingredion), and modified cellulose polymers (e.g., hydroxypropylmethylcellulose, methylcellulose, and carboxymethylcellulose);
and mixtures thereof.

### Methods for Enhancing Salty Taste of a Comestible

The present disclosure also provides a method of producing a comestible, by incorporating the seasoning composition, in one or more of its embodiments, into the comestible, to obtain a comestible in which the richness, savoriness, initial salty taste, and/or overall salty taste of the comestible is enhanced. In particular, the initial salty taste is often most difficult to improve, and thus a preferred benefit of the present disclosure is the ability to enhance an initial salty taste of a comestible by incorporation of the seasoning composition.

The step of incorporating the seasoning composition may be performed at any of the various stages of the comestible manufacturing process, and may be performed using a seasoning composition in the form of a dry blend (substantially free of water) or a wet blend (e.g., aqueous solution). Those skilled in the art can appropriately design production steps for the incorporation of the seasoning composition, using any other raw or base ingredient(s) needed to form the comestible, in any desirable raw or base ingredient ratio and/or concentration, and the comestible may be prepared using known techniques.

In some embodiments, the methods involve combining the seasoning composition with other raw or base ingredients to prepare the comestible, e.g., ‘from scratch’. The seasoning composition ingredients may be added together or separately, to and/or with any raw or base ingredients needed to make the comestible, during assembly/preparation of the comestible. For example, the seasoning composition may be added as an ingredient (e.g., similar to how sodium chloride is used) when following a recipe to make the comestible—i.e., the seasoning composition may be used as a substitute for the full amount of sodium chloride normally used to make a full salt variety of the comestible, in order to provide a comestible having a reduced-sodium content.

In one non-limiting example, to make a reduced-sodium chicken soup, the seasoning composition may be incorporated into a dry blend with other raw or base ingredients used to make chicken soup (e.g., sugar, chicken fat, chicken flavor, chicken stock powder, onion powder, etc.), and the dry blend may be mixed with water in an appropriate amount (e.g., 2 to 5 wt. % dry blend) to form a reduced-sodium chicken soup. In another non-limiting example, the seasoning composition may be used as a final seasoning to season potato chips.

In some embodiments, the seasoning composition is added to a pre-made comestible, preferably a pre-made comestible having a reduced-sodium content that is in need of flavor enhancement, in order to achieve an enhanced taste profile. For example, the seasoning composition may be added to a pre-made reduced-sodium comestible, light in sodium comestible, low sodium comestible, very low sodium comestible, or sodium-free comestible for taste enhancement, preferably initial taste enhancement. In preferred embodiments, the seasoning composition is incorporated into the pre-made reduced-sodium comestible, light in sodium comestible, low sodium comestible, very low sodium comestible, or sodium-free comestible, in an amount which provides a comestible containing the seasoning composition having a reduced-sodium content.

In one non-limiting example, the seasoning composition may be added into a low sodium tomato juice in an amount to provide a reduced-sodium tomato juice with an enhanced taste.

The examples below are intended to further illustrate seasoning compositions, comestibles prepared therefrom, and their methods of manufacture, and are not intended to limit the scope of the claims.

### EXAMPLES

### Materials

The sea salt used in the below examples was TWO SEAS LOW SODIUM SEA SALT SS50 NF, which is a natural low sodium sea salt (50/50 KCl/NaCl by weight), based on a blend of sea salts harvested from the mineral-rich Dead Sea and the Red Sea, available from A & B Ingredients, Inc.

I+G denotes a mixture of inosine monophosphate (IMP) and guanosine monophosphate (GMP) in a weight ratio of 1:1.

L-Glu denotes L-glutamic acid. MSG denotes monosodium glutamate. MPG denotes monopotassium glutamate. NH₄Glu denotes monoammonium glutamate.

HR-Pd denotes YEASTOCK HR-Pd, which is a yeast extract containing inosine monophosphate (IMP), guanosine monophosphate (GMP), and L-glutamic acid, and is available from Asahi Group Foods, Ltd.

The sugar used was sucrose (table sugar).

In the below tables, positive controls (Control+) were formed using seasoning compositions made from 100 wt. % (dry basis) sodium chloride (full sodium comestible). Negative controls (Control−) were formed using seasoning compositions made from 100 wt. % (dry basis) sea salt or NaCl/KCl mixtures (1:1 by weight).

“In” denotes that the referenced ratio of ingredients falls within a preferred range as described in the DETAILED DESCRIPTION OF THE INVENTION section.

* denotes the example is a comparative example.

### Evaluation Methods

The seasoning compositions were evaluated by trained panelists with experience in profiling and prescreened for their sensory acuity. The trained panelists evaluated comestibles containing the seasoning compositions for initial salty taste and overall salty taste according to the saltiness intensity ratings of Table 1.

TABLE 1
Saltiness intensity

| Rating | Description |
|---|---|
| (−/−) | Too weak |
| (−) | Weak |
| (±) | Moderate |
| (+) | Sufficient |
| (+/+) | Strong |

### Chicken Soup Application

Chicken soups were prepared from dry blends containing (i) the seasoning compositions and (ii) raw or base ingredients listed in Tables 2-6. The amount of each listed ingredient is expressed in terms of weight percentage relative to a total weight of the dry blend (100%). Supplemental maltodextrin was added to the positive and negative control instead of umami substances to maintain consistency across dry blends at 100 wt. %.

To make the chicken soups, the dry blends were formed by mixing together each of the listed ingredients until uniform. Then, the dry blends were applied to hot water at a loading of 3 wt. % and stirred to produce the chicken soups, which were evaluated by trained panelists according to the rating system of Table 1.

TABLE 2

| | | Control | Control | Ex. | Ex. | Ex. | Ex. | Ex. | Ex. | Ex. |
|---|---|---|---|---|---|---|---|---|---|---|
| Dry Blend | | + | − | 1 | 2* | 3* | 4* | 5* | 6* | 7* |
| Seasoning | Symbol | | | | | | | | | |
| Comp. | | | | | | | | | | |
| NaCl | A | 18.0 | — | — | — | — | — | — | — | — |
| Sea salt | A + B | — | 18.0 | 18.0 | 18.0 | 18.0 | 18.0 | 18.0 | 18.0 | 18.0 |
| I + G | C | — | — | 1.0 | 1.5 | — | — | — | — | — |
| IMP | — | — | — | — | — | 1.5 | — | — | — | — |
| L-Glu | D | — | — | 0.5 | — | — | 1.5 | — | — | — |
| MSG | | — | — | — | — | — | — | 1.5 | — | — |
| MPG | | — | — | — | — | — | — | — | 1.5 | — |
| NH₄Glu | | — | — | — | — | — | — | — | — | 1.5 |

| | | | | | | | | | |
|---|---|---|---|---|---|---|---|---|---|
| Raw/Base Ingredients | | | | | | | | | |
| Sugar | 6.0 | 6.0 | 6.0 | 6.0 | 6.0 | 6.0 | 6.0 | 6.0 | 6.0 |
| Chicken fat | 6.0 | 6.0 | 6.0 | 6.0 | 6.0 | 6.0 | 6.0 | 6.0 | 6.0 |
| Chicken stock powder | 15.0 | 15.0 | 15.0 | 15.0 | 15.0 | 15.0 | 15.0 | 15.0 | 15.0 |
| Onion powder | 3.0 | 3.0 | 3.0 | 3.0 | 3.0 | 3.0 | 3.0 | 3.0 | 3.0 |
| Vegetable powder | 8.0 | 8.0 | 8.0 | 8.0 | 8.0 | 8.0 | 8.0 | 8.0 | 8.0 |
| White pepper | 0.2 | 0.2 | 0.2 | 0.2 | 0.2 | 0.2 | 0.2 | 0.2 | 0.2 |
| Maltodextrin | 38.8 | 38.8 | 37.3 | 37.3 | 37.3 | 37.3 | 37.3 | 37.3 | 37.3 |
| Chicken flavor | 5.0 | 5.0 | 5.0 | 5.0 | 5.0 | 5.0 | 5.0 | 5.0 | 5.0 |
| Total | 100.0 | 100.0 | 100.0 | 100.0 | 100.0 | 100.0 | 100.0 | 100.0 | 100.0 |
| (B):(A) | — | 1:1 | 1:1 | 1:1 | 1:1 | 1:1 | 1:1 | 1:1 | 1:1 |
| (C):(D) | — | — | 2:1 | — | — | — | — | — | — |
| (B):(D) | — | — | 18:1 | — | — | 6:1 | 6:1 | 6:1 | 6:1 |
| (C) + (D):(A) + (B) | — | — | 0.083:1 | 0.083:1 | — | 0.083:1 | 0.083:1 | 0.083:1 | 0.083:1 |
| Overall salty taste | (+/+) | (−/−) | (+/+) | (±) | (±) | (±) | (±) | (±) | (±) |
| Initial salty taste | (+/+) | (−/−) | (+/+) | (−) | (−) | (−) | (−) | (−) | (−) |

TABLE 3

| | | Control | Control | Ex. | Ex. | Ex. | Ex. | Ex. | Ex. |
|---|---|---|---|---|---|---|---|---|---|
| Dry Blend | | + | − | 1 | 8 | 9* | 10* | 11* | 12 |
| Seasoning | Symbol | | | | | | | | |
| Comp. | | | | | | | | | |
| NaCl | A | 18.0 | — | — | — | — | — | — | — |
| Sea salt | A + B | — | 18.0 | 18.0 | 18.0 | 18.0 | 18.0 | 18.0 | 18.0 |
| I + G | C | — | — | 1.0 | — | — | — | 1.0 | 1.0 |
| IMP | — | — | — | — | — | 1.0 | — | — | — |
| HR-Pd | C + D | — | — | — | 5.0 | — | — | — | — |
| L-Glu | D | — | — | 0.5 | — | 0.5 | 0.5 | — | — |
| MSG | | — | — | — | — | — | — | — | 0.5 |
| Disodium | — | — | — | — | — | — | 1.0 | 0.5 | — |
| succinate | | | | | | | | | |

| | | | | | | | | |
|---|---|---|---|---|---|---|---|---|
| Raw/Base Ingredients | | | | | | | | |
| Sugar | 6.0 | 6.0 | 6.0 | 6.0 | 6.0 | 6.0 | 6.0 | 6.0 |
| Chicken fat | 6.0 | 6.0 | 6.0 | 6.0 | 6.0 | 6.0 | 6.0 | 6.0 |
| Chicken stock powder | 15.0 | 15.0 | 15.0 | 15.0 | 15.0 | 15.0 | 15.0 | 15.0 |
| Onion powder | 3.0 | 3.0 | 3.0 | 3.0 | 3.0 | 3.0 | 3.0 | 3.0 |
| Vegetable powder | 8.0 | 8.0 | 8.0 | 8.0 | 8.0 | 8.0 | 8.0 | 8.0 |
| White pepper | 0.2 | 0.2 | 0.2 | 0.2 | 0.2 | 0.2 | 0.2 | 0.2 |
| Maltodextrin | 38.8 | 38.8 | 37.3 | 33.8 | 37.3 | 37.3 | 37.3 | 37.3 |
| Chicken flavor | 5.0 | 5.0 | 5.0 | 5.0 | 5.0 | 5.0 | 5.0 | 5.0 |
| Total | 100.0 | 100.0 | 100.0 | 100.0 | 100.0 | 100.0 | 100.0 | 100.0 |
| (B):(A) | — | 1:1 | 1:1 | 1:1 | 1:1 | 1:1 | 1:1 | 1:1 |
| (C):(D) | — | — | 2:1 | “In” | — | — | — | 2:1 |
| (B):(D) | — | — | 18:1 | “In” | 18:1 | 18:1 | — | 18:1 |
| (C) + (D):(A) + (B) | — | — | 0.083:1 | “In” | 0.028:1 | 0.028:1 | 0.056:1 | 0.083:1 |
| Overall salty taste | (+/+) | (−/−) | (+/+) | (+/+) | (±) | (±) | (±) | (+/+) |
| Initial salty taste | (+/+) | (−/−) | (+/+) | (+/+) | (−) | (−) | (−) | (+/+) |

As shown in Table 2, positive control (full sodium content) provided an excellent salty taste, both initially and overall, while the negative control prepared using sea salt was bitter and lacked salt intensity. The seasoning composition made from low-sodium sea salt and a mixture of (i) inosine monophosphate (IMP) and guanosine monophosphate (GMP) and (ii) glutamic acid as umami substances (Example 1), was found to provide an excellent salty taste enhancement to the chicken soup, with overall and initial salty taste intensities similar to those of full sodium chicken soup (positive control). On the other hand, seasoning compositions formulated with only I+G (Example 2*), only IMP (Example 3*), or only glutamic acid or salt thereof (Examples 4-7*) as umami substances were able to mask metallic notes and enhance umami, but failed to provide an initial salty taste enhancement.

As shown in Table 3, seasoning compositions made from umami substances inosine monophosphate (IMP), guanosine monophosphate (GMP), and L-glutamic acid provided in the form of a yeast extract (YEASTOCK HR-Pd)(Example 8) performed similarly to Example 1, both of which enhanced umami, masked metallic notes from potassium chloride, while also enhancing initial salty taste and overall salty taste. Also, salts of glutamic acid such as monosodium glutamate (MSG) were equivalent to glutamic acid, and provided desirable salty taste enhancement when used in combination with two nucleotides (Example 12).

Unexpectedly, the seasoning composition made from a single nucleotide, IMP, and glutamic acid (Example 9*) was able to improve the overall salty taste to a certain extent through enhanced umami and aftertaste improvement, but did not provide a suitable improvement in the initial salty taste, and was given a weak initial salty taste rating. Likewise, seasoning compositions in which the two nucleotides, I+G, were replaced with disodium succinate (Example 10*), or where glutamic acid was replaced with disodium succinate (Example 11*), both led to only marginal increases in overall salty taste, with inadequate initial salty taste scores. These results demonstrate the importance of having a mixture of nucleotides and also glutamic acid or a salt thereof as umami substances for initial salty taste, in particular.

TABLE 4

| | | Control | Ex. | Ex. | Ex. | Ex. | Ex. | Ex. | Ex. | Ex. |
|---|---|---|---|---|---|---|---|---|---|---|
| Dry Blend | | + | 1 | 13* | 14 | 15 | 16 | 17 | 18 | 19 |
| Seasoning | Symbol | | | | | | | | | |
| Comp. | | | | | | | | | | |
| NaCl | A | 18.0 | — | 6.0 | 7.0 | 8.0 | 9.0 | 10.0 | 11.0 | 12.0 |
| KCl | B | — | — | 12.0 | 11.0 | 10.0 | 9.0 | 8.0 | 7.0 | 6.0 |
| Sea salt | A + B | — | 18.0 | — | — | — | — | — | — | — |
| I + G | C | — | 1.0 | 1.0 | 1.0 | 1.0 | 1.0 | 1.0 | 1.0 | 1.0 |
| L-Glu | D | — | 0.5 | 0.5 | 0.5 | 0.5 | 0.5 | 0.5 | 0.5 | 0.5 |

| | | | | | | | | | |
|---|---|---|---|---|---|---|---|---|---|
| Raw/Base Ingredients | | | | | | | | | |
| Sugar | 6.0 | 6.0 | 6.0 | 6.0 | 6.0 | 6.0 | 6.0 | 6.0 | 6.0 |
| Chicken fat | 6.0 | 6.0 | 6.0 | 6.0 | 6.0 | 6.0 | 6.0 | 6.0 | 6.0 |
| Chicken stock powder | 15.0 | 15.0 | 15.0 | 15.0 | 15.0 | 15.0 | 15.0 | 15.0 | 15.0 |
| Onion powder | 3.0 | 3.0 | 3.0 | 3.0 | 3.0 | 3.0 | 3.0 | 3.0 | 3.0 |
| Vegetable powder | 8.0 | 8.0 | 8.0 | 8.0 | 8.0 | 8.0 | 8.0 | 8.0 | 8.0 |
| White pepper | 0.2 | 0.2 | 0.2 | 0.2 | 0.2 | 0.2 | 0.2 | 0.2 | 0.2 |
| Maltodextrin | 38.8 | 37.3 | 37.3 | 37.3 | 37.3 | 37.3 | 37.3 | 37.3 | 37.3 |
| Chicken flavor | 5.0 | 5.0 | 5.0 | 5.0 | 5.0 | 5.0 | 5.0 | 5.0 | 5.0 |
| Total | 100.0 | 100.0 | 100.0 | 100.0 | 100.0 | 100.0 | 100.0 | 100.0 | 100.0 |
| (B):(A) | — | 1:1 | 2:1 | 1.57:1 | 1.25:1 | 1:1 | 0.8:1 | 0.64:1 | 0.5:1 |
| (C):(D) | — | 2:1 | 2:1 | 2:1 | 2:1 | 2:1 | 2:1 | 2:1 | 2:1 |
| (B):(D) | — | 18:1 | 24:1 | 22:1 | 20:1 | 18:1 | 16:1 | 14:1 | 12:1 |
| (C) + (D):(A) + (B) | — | 0.083:1 | 0.083:1 | 0.083:1 | 0.083:1 | 0.083:1 | 0.083:1 | 0.083:1 | 0.083:1 |
| Overall salty taste | (+/+) | (+/+) | (−) | (±) | (+) | (+/+) | (+/+) | (+/+) | (+/+) |
| Initial salty taste | (+/+) | (+/+) | (−) | (±) | (+) | (+/+) | (+/+) | (+/+) | (+/+) |

In terms of the amount of sodium chloride that can be replaced with potassium chloride, Example 13* indicates that a potassium chloride to sodium chloride ratio of 2:1 is too high, i.e., there is not enough sodium chloride present, and too much potassium chloride, and the undesirable aftertaste characteristics (e.g., astringency, metallic flavors, etc.) imparted by potassium chloride are too strong for the umami substances to compensate (Table 4). Thus, Example 13* received a weak rating for both initial salty taste and overall salty taste. Decreasing the potassium chloride to sodium chloride ratio slightly to 1.57:1 provided acceptable results and a moderate salt intensity rating (Example 14), with further decreases in the potassium chloride to sodium chloride ratio providing further improvements to the initial and overall saltiness scores (Examples 15-19).

TABLE 5

| | | Control | Control | Ex. | Ex. | Ex. | Ex. | Ex. | Ex. | Ex. |
|---|---|---|---|---|---|---|---|---|---|---|
| Dry Blend | | + | − | 20* | 21 | 22 | 23 | 1 | 24 | 25 |
| Seasoning | Symbol | | | | | | | | | |
| Comp. | | | | | | | | | | |
| NaCl | A | 18.0 | — | — | — | — | — | — | — | — |
| Sea salt | A + B | — | 18.0 | 18.0 | 18.0 | 18.0 | 18.0 | 18.0 | 18.0 | 18.0 |
| I + G | C | — | — | 0.7 | 0.75 | 0.8 | 0.9 | 1.0 | 1.20 | 1.25 |
| L-Glu | D | — | — | 0.8 | 0.75 | 0.7 | 0.6 | 0.5 | 0.3 | 0.25 |

| | | | | | | | | | |
|---|---|---|---|---|---|---|---|---|---|
| Raw/Base Ingredients | | | | | | | | | |
| Sugar | 6.0 | 6.0 | 6.0 | 6.0 | 6.0 | 6.0 | 6.0 | 6.0 | 6.0 |
| Chicken fat | 6.0 | 6.0 | 6.0 | 6.0 | 6.0 | 6.0 | 6.0 | 6.0 | 6.0 |
| Chicken stock powder | 15.0 | 15.0 | 15.0 | 15.0 | 15.0 | 15.0 | 15.0 | 15.0 | 15.0 |
| Onion powder | 3.0 | 3.0 | 3.0 | 3.0 | 3.0 | 3.0 | 3.0 | 3.0 | 3.0 |
| Vegetable powder | 8.0 | 8.0 | 8.0 | 8.0 | 8.0 | 8.0 | 8.0 | 8.0 | 8.0 |
| White pepper | 0.2 | 0.2 | 0.2 | 0.2 | 0.2 | 0.2 | 0.2 | 0.2 | 0.2 |
| Maltodextrin | 38.8 | 38.8 | 37.3 | 37.3 | 37.3 | 37.3 | 37.3 | 37.3 | 37.3 |
| Chicken flavor | 5.0 | 5.0 | 5.0 | 5.0 | 5.0 | 5.0 | 5.0 | 5.0 | 5.0 |
| Total | 100.0 | 100.0 | 100.0 | 100.0 | 100.0 | 100.0 | 100.0 | 100.0 | 100.0 |
| (B):(A) | — | 1:1 | 1:1 | 1:1 | 1:1 | 1:1 | 1:1 | 1:1 | 1:1 |
| (C):(D) | — | — | 0.875:1 | 1:1 | 1.14:1 | 1.5:1 | 2:1 | 4:1 | 5:1 |
| (B):(D) | — | — | 11.25:1 | 12:1 | 12.86:1 | 15:1 | 18:1 | 30:1 | 36:1 |
| (C) + (D):(A) + (B) | — | — | 0.083:1 | 0.083:1 | 0.083:1 | 0.083:1 | 0.083:1 | 0.083:1 | 0.083:1 |
| Overall salty taste | (+/+) | (−/−) | (−) | (±) | (+) | (+/+) | (+/+) | (+) | (±) |
| Initial salty taste | (+/+) | (−/−) | (−) | (±) | (+) | (+/+) | (+/+) | (+) | (±) |

The effects of the relative ratio of the nucleotides to glutamic acid, (C):(D), were also explored and the results are presented in Table 5. Example 20* was prepared with a ratio of I+G to glutamic acid of 0.875:1, and failed to provide a salt enhancement, while increasing the (C):(D) ratio to 1:1 provided moderate salty taste ratings (Example 21). Further improvements to initial and overall salty taste were seen upon increasing I+G to glutamic acid ratios (Examples 22, 23, 1, and 24) up to a (C):(D) ratio of 5:1, which provided moderate salty taste ratings (Example 25). These results indicate that acceptable salt enhancement can be achieved using seasoning compositions with a relative ratio of the nucleotides to glutamic acid, (C):(D), of 1:1 to 5:1, with the most desirable salty taste enhancement results being obtained with (C):(D) ratios of 1.14:1 to 4:1.

TABLE 6

| | | Control | Control | Control | Ex. | Ex. |
|---|---|---|---|---|---|---|
| Dry Blend | | + | − | − | 8 | 26 |
| Seasoning | Symbol | | | | | |
| Comp. | | | | | | |
| NaCl | A | 18.0 | — | 9.0 | — | 9.0 |
| KCl | B | — | — | 9.0 | — | 9.0 |
| Sea salt | A + B | — | 18.0 | — | 18.0 | — |
| HR-Pd | C + D | — | — | — | 5.0 | 5.0 |

| | | | | | |
|---|---|---|---|---|---|
| Raw/Base Ingredients | | | | | |
| Sugar | 6.0 | 6.0 | 6.0 | 6.0 | 6.0 |
| Chicken fat | 6.0 | 6.0 | 6.0 | 6.0 | 6.0 |
| Chicken stock powder | 15.0 | 15.0 | 15.0 | 15.0 | 15.0 |
| Onion powder | 3.0 | 3.0 | 3.0 | 3.0 | 3.0 |
| Vegetable powder | 8.0 | 8.0 | 8.0 | 8.0 | 8.0 |
| White pepper | 0.2 | 0.2 | 0.2 | 0.2 | 0.2 |
| Maltodextrin | 38.8 | 38.8 | 38.8 | 33.8 | 33.8 |
| Chicken flavor | 5.0 | 5.0 | 5.0 | 5.0 | 5.0 |
| Total | 100.0 | 100.0 | 100.0 | 100.0 | 100.0 |
| (B):(A) | — | 1:1 | 1:1 | 1:1 | 1:1 |
| (C):(D) | — | — | — | “In” | “In” |
| (B):(D) | — | — | — | “In” | “In” |
| (C) + (D):(A) + (B) | — | — | — | “In” | “In” |
| Overall salty taste | (+/+) | (−/−) | (−/−) | (+/+) | (+/+) |
| Initial salty taste | (+/+) | (−/−) | (−/−) | (+/+) | (+/+) |

As shown in Table 6, chicken soups prepared using negative controls of either sea salt or a mixture of NaCl and KCl lacked initial salty taste, and suffered from metallic after taste due to the presence of KCl. On the contrary, seasoning compositions made from either sea salt or a mixture of NaCl and KCl, and umami substances inosine monophosphate (IMP), guanosine monophosphate (GMP), and L-glutamic acid provided in the form of a yeast extract (YEASTOCK HR-Pd)(Examples 8 and 26) enhanced umami and chicken flavor, and masked metallic notes from potassium chloride. Overall, Examples 8 and 26 were rated similarly to positive control prepared using full sodium content, each receiving excellent initial salty taste and overall salty taste ratings.

### Soy Sauce Application

Samples were prepared according to Table 7 from a commercially available standard soy sauce by diluting 10 times with an aqueous salt solution (2 wt. % NaCl or 2 wt. % sea salt in water), and HR-Pd for umami substances. The amount of each listed ingredient is expressed in terms of relative weight. The soy sauces were then evaluated by trained panelists according to the rating system of Table 1.

As shown in Table 7, the full sodium soy sauce (positive control) had a nice sharp initial salty taste. Similarly, Example 27, prepared with a seasoning composition of sea salt and HR-Pd for umami substances, also had an excellent initial salty taste, and was given strong saltiness ratings that matched positive control (full sodium soy sauce). The soy sauce prepared using only sea salt (negative control) on the other hand, lacked the desired sharp initial salty taste.

TABLE 7

| Seasoning | | | | |
|---|---|---|---|---|
| Comp. | Symbol | Control+ | Control− | Ex. 27 |
| aq. NaCl solution | A | 90.0 | — | — |
| (2 wt. % NaCl in water) | | | | |
| aq. Sea salt solution | A + B | — | 90.0 | 90.0 |
| (2 wt. % sea salt in water) | | | | |
| HR-Pd | C + D | — | — | 0.05 |

| | | | |
|---|---|---|---|
| Raw/Base Ingredients | | | |
| Soy sauce | 10.0 | 10.0 | 10.0 |
| Total | 100.0 | 100.0 | 100.05 |
| (B):(A) | — | 1:1 | 1:1 |
| (C):(D) | — | — | “In” |
| (B):(D) | — | — | “In” |
| (C) + (D):(A) + (B) | — | — | “In” |
| Overall salty taste | (+/+) | (−/−) | (+/+) |
| Initial salty taste | (+/+) | (−/−) | (+/+) |

### Tomato Juice Application

Tomato juices were prepared according to Table 8 from a low sodium tomato juice (58.33 mg Na per 100 g of the low sodium tomato juice), sodium chloride or sea salt, and HR-Pd for umami substances. The amount of each listed ingredient is expressed in terms of relative weight. The total sodium content of each control sample/example is also provided in terms of mg Na per 100 g. The tomato juices were then evaluated by trained panelists according to the rating system of Table 1.

The positive control received high ratings from the panelists, with a rich tomato flavor and slight sour notes (Table 8). The seasoning composition of Example 28, made from sea salt and HR-Pd for umami substances, when added to low-sodium tomato juice, provided a reduced-sodium tomato juice with an excellent salty taste profile, with no bitter taste or sour notes. The reduced-sodium tomato juice of Example 28 received strong saltiness ratings comparable to the full sodium positive control, even though the sodium content was reduced by about 40%. The reduced-sodium tomato juice prepared using only sea salt (negative control) on the other hand, was rated weak in terms of salty taste, and had slight metallic notes.

TABLE 8

| Seasoning | | | | |
|---|---|---|---|---|
| Comp. | Symbol | Control+ | Control− | Ex. 28 |
| NaCl | A | 0.59 | — | — |
| Sea salt | A + B | — | 0.59 | 0.59 |
| HR-Pd | C + D | — | — | 0.025 |

| | | | |
|---|---|---|---|
| Raw/Base Ingredients | | | |
| Low sodium tomato juice | 99.41 | 99.41 | 99.41 |
| Total | 100.0 | 100.0 | 100.025 |
| mg Na/100 g | 289.9 | 173.9 | 173.9 |
| (B):(A) | — | 1:1 | 1:1 |
| (C):(D) | — | — | “In” |
| (B):(D) | — | — | “In” |
| (C) + (D):(A) + (B) | — | — | “In” |
| Overall salty taste | (+/+) | (−/−) | (+/+) |
| Initial salty taste | (+/+) | (−/−) | (+/+) |

### Potato Chip Application

Potato chips were prepared according to Table 9 using potato chips (unsalted), sodium chloride or sea salt, and HR-Pd for umami substances. The amount of each listed ingredient is expressed in terms of relative weight. The potato chips were then evaluated by trained panelists according to the rating system of Table 1.

As shown in Table 9, full sodium potato chips (positive control) and the potato chips of Example 29, prepared using a seasoning composition of sea salt and HR-Pd for umami substances, each had acceptable saltiness—while the negative control, prepared using only sea salt, lacked initial salty taste and panelists experienced slight bitter notes.

TABLE 9

| Seasoning | | | | |
|---|---|---|---|---|
| Comp. | Symbol | Control+ | Control− | Ex. 29 |
| NaCl | A | 0.5 | — | — |
| Sea salt | A + B | — | 0.5 | 0.5 |
| HR-Pd | C + D | — | — | 0.05 |

| | | | |
|---|---|---|---|
| Raw/Base Ingredients | | | |
| Potato chips (unsalted) | 99.5 | 99.5 | 99.5 |
| Total | 100.0 | 100.0 | 100.05 |
| (B):(A) | — | 1:1 | 1:1 |
| (C):(D) | — | — | “In” |
| (B):(D) | — | — | “In” |
| (C) + (D):(A) + (B) | — | — | “In” |
| Overall salty taste | (+/+) | (−/−) | (+/+) |
| Initial salty taste | (+/+) | (−/−) | (+/+) |

### Plant-Based Protein Application

Structured soy protein was prepared according to Table 10 using sodium free (0 wt. % sodium chloride) structured soy protein, sodium chloride or sea salt, HR-Pd or a combination of I+G and MSG for umami substances, and water. The amount of each listed ingredient is expressed in terms of weight in grams.

To prepare, each sample was hydrated for 1 hour at room temperature, and then heated by microwave for 30 seconds. The samples were then cooled down to room temperature and evaluated by trained panelists according to the rating system of Table 1.

TABLE 10

| Seasoning | | | | | |
|---|---|---|---|---|---|
| Comp. | Symbol | Control+ | Control− | Ex. 30 | Ex. 31 |
| NaCl | A | 0.2 | — | — | — |
| Sea salt | A + B | — | 0.2 | 0.2 | 0.2 |
| I + G | C | — | — | — | 0.006 |
| HR-Pd | C + D | — | — | 0.03 | — |
| MSG | D | — | — | — | 0.003 |

| | | | | |
|---|---|---|---|---|
| Raw/Base Ingredients | | | | |
| Water | 10.0 | 10.0 | 10.0 | 10.0 |
| Structured soy protein | 10.0 | 10.0 | 10.0 | 10.0 |
| (0 wt. % NaCl) | | | | |
| Total (g) | 20.2 | 20.2 | 20.23 | 20.21 |
| (B):(A) | — | 1:1 | 1:1 | 1:1 |
| (C):(D) | — | — | “In” | 2:1 |
| (B):(D) | — | — | “In” | 33.3:1 |
| (C) + (D):(A) + (B) | — | — | “In” | 0.045:1 |
| Overall salty taste | (+/+) | (−/−) | (+/+) | (+/+) |
| Initial salty taste | (+/+) | (−/−) | (+/+) | (+/+) |

The structured soy protein of Example 30 (prepared using a seasoning composition of sea salt and HR-Pd for umami substances) and Example 31 (prepared using a seasoning composition made from sea salt and umami substances of inosine monophosphate, guanosine monophosphate, and glutamic acid) each had an enhanced umami taste and were given a strong rating for overall and initial salty taste. These scores were markedly better than the structured soy protein prepared using only sea salt (negative control).

Where a numerical limit or range is stated herein, the endpoints are included. Also, all values and subranges within a numerical limit or range are specifically included as if explicitly written out.

As used herein the words “a” and “an” and the like carry the meaning of “one or more.”

The present disclosure also contemplates other embodiments “comprising”, “consisting of” and “consisting essentially of”, the embodiments or elements presented herein, whether explicitly set forth or not.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A seasoning composition, comprising:
(A) sodium chloride;
(B) potassium chloride;
(C) at least two nucleotides; and
(D) glutamic acid or salt thereof;
wherein:
a weight ratio of the at least two nucleotides to the glutamic acid or salt thereof, (C):(D), is from 1:1 to 5:1, and
a weight ratio of potassium chloride to the glutamic acid or salt thereof, (B):(D), is from 10:1 to 250:1.

2. The seasoning composition of claim 1, wherein a weight ratio of potassium chloride to sodium chloride, (B):(A), is less than 2:1.

3. The seasoning composition of claim 1, wherein a weight ratio of potassium chloride to sodium chloride, (B):(A), is less than 1.5:1.

4. The seasoning composition of claim 1, wherein the at least two nucleotides are selected from the group consisting of, inosine monophosphate, guanosine monophosphate, and adenosine monophosphate.

5. The seasoning composition of claim 1, wherein the at least two nucleotides and the glutamic acid or salt thereof are provided in the form of a yeast extract.

6. The seasoning composition of claim 1, in which exactly two nucleotides are present.

7. The seasoning composition of claim 6, wherein the two nucleotides are present in a weight ratio of 1:2 to 2:1.

8. The seasoning composition of claim 6, wherein the two nucleotides are inosine monophosphate and guanosine monophosphate.

9. The seasoning composition of claim 1, wherein the glutamic acid or salt thereof is selected from the group consisting of glutamic acid, monosodium glutamate, monopotassium glutamate, calcium diglutamate, monoammonium glutamate, and magnesium diglutamate.

10. The seasoning composition of claim 1, wherein the weight ratio of the at least two nucleotides to the glutamic acid or salt thereof, (C):(D), is from 1.14:1 to 4.5:1.

11. The seasoning composition of claim 1, wherein the weight ratio of potassium chloride to the glutamic acid or salt thereof, (B):(D), is from 12:1 to 225:1.

12. The seasoning composition of claim 1, wherein a weight ratio of a combined weight of the at least two nucleotides and the glutamic acid or salt thereof to a combined weight of the sodium chloride and the potassium chloride, (C)+(D):(A)+(B), is less than 0.1:1.

13. The seasoning composition of claim 1, wherein a weight ratio of a combined weight of the at least two nucleotides and the glutamic acid or salt thereof to a combined weight of the sodium chloride and the potassium chloride, (C)+(D):(A)+(B), is from 0.005:1 to 0.085:1.

14. The seasoning composition of claim 1, wherein the glutamic acid or salt thereof is present in an amount of 0.1 to 10 wt. %, based on a total weight of the seasoning composition on a dry basis.

15. A comestible, comprising the seasoning composition of claim 1.

16. The comestible of claim 15, wherein:
a weight ratio of potassium chloride to sodium chloride, (B):(A), is less than 2:1, and
a weight ratio of a combined weight of the at least two nucleotides and the glutamic acid or salt thereof to a combined weight of the sodium chloride and the potassium chloride, (C)+(D):(A)+(B), is less than 0.1:1.

17. The comestible of claim 15, which is a reduced-sodium comestible.

18. A method of enhancing an initial salty taste of a comestible, comprising incorporating the seasoning composition of claim 1 into the comestible.

19. The method of claim 18, wherein:
a weight ratio of potassium chloride to sodium chloride, (B):(A), is less than 2:1, and
a weight ratio of a combined weight of the at least two nucleotides and the glutamic acid or salt thereof to a combined weight of the sodium chloride and the potassium chloride, (C)+(D):(A)+(B), is less than 0.1:1.

20. The method of claim 18, wherein the comestible is a reduced-sodium comestible.
